(19) United States
(12) Patent Application Publication
(10) Pub. No.: US 2019/0102625 A1
(43) Pub. Date: Apr. 4, 2019

(54) ENTITY ATTRIBUTE IDENTIFICATION

(71) Applicant: Microsoft Technology Licensing, LLC, Redmond, WA (US)

(72) Inventor: Sreevani Tippana, Redmond, WA (US)

(73) Assignee: Microsoft Technology Licensing, LLC, Redmond, WA (US)

(21) Appl. No.: 15/720,713

(22) Filed: Sep. 29, 2017

(51) Int. Cl. G06K 9/00; G06T 19/00; G06F 17/30; G10L 15/26

(52) U.S. Cl. CPC G06K 9/00671; G06T 19/006; G10L 15/265; G06F 17/30867; G06F 17/30654

(57) ABSTRACT

Entity attribute identification is provided. An entity attribute identification system includes components configured to receive a user query corresponding to a particular attribute, capture an image including an entity of interest (EOI), identify the EOI, retrieve information associated with the identified EOI, make a determination as to whether information associated with the identified EOI matches the particular attribute, and notify the user as to whether the identified EOI has an association with the particular attribute. In some examples, the entity attribute identification system uses augmented reality methods to mediate the user's visual perception of the environment with information associated with an identified EOI, such as information corresponding to whether the EOI has an association with the particular attribute.

### BACKGROUND

There are a variety of scenarios where an individual can benefit from receiving information corresponding to entities in the individual's environment. For example, an individual may need to find a person who has expertise or experience with a particular subject matter and can assist with the individual's need (e.g., a person in an enterprise may need help with an on-call matter, a patron of a store may need to find someone who can assist with a particular issue, a manager may need to identify one or more workers who can perform a certain duty or task). In another example, an individual may wish to identify someone out of a crowd who shares a similar interest. In another example, an individual may be near a building in an unfamiliar city and may need to know whether a particular service is offered by a business located within the building. In another example, an individual may be in the presence of an animal and may wish to know whether the animal has a certain known characteristics, such as whether the animal breed is typically good with children, is easily trainable, is suited for an apartment or small space, or is venomous.

Individuals may find it challenging and time consuming to collect and make sense of data about entities in an environment, particularly when the individual is unfamiliar with the environment or with the entities within it. Currently, an individual may interrupt coworkers or send a mass communication or individual communications to find someone who can help with a subject or need, or may search for information about people or other entities around him/her or in the individual's organization to identify someone who can help. As can be appreciated, these approaches can be inefficient, disruptive, and unproductive.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer readable storage device for providing entity attribute identification. An entity attribute identification system is provided that includes components configured to receive a user query corresponding to a particular attribute, receive an image including an entity of interest (EOI), identify the EOI, retrieve information associated with the identified EOI, make a determination as to whether information associated with the identified EOI matches the particular attribute, and notify the user as to whether the identified EOI has an association with the particular attribute. In some examples, the entity attribute identification system uses computer mediated reality (e.g., augmented reality (AR)) methods to mediate the user's visual perception of the environment with information associated with an identified EOI, such as information corresponding to whether the EOI has an association with the particular attribute.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process. The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram showing an example operating environment for implementation of the present disclosure;

FIG. 2 is a block diagram showing an example entity attribute identification system for implementation of the present disclosure;

FIGS. 3A-B are illustrations of an example use case scenario and example GUI;

FIGS. 4A-D are illustrations of an example use case scenario and example AR UIs;

FIGS. 5A-B are illustrations of an example use case scenario and an example AR UI;

FIG. 6 is a flow chart showing general stages involved in an example method for providing entity attribute identification;

FIG. 7 is a block diagram illustrating example physical components of a computing device;

FIGS. 8A and 8B are simplified block diagrams of a mobile computing device; and

FIG. 9 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer readable storage device for providing entity attribute identification. Advantageously, aspects of the present disclosure improve user experience by providing relevant information to a user within the context of the user's environment in real time or near real time, which is not only efficient, but is non-disruptive to other individuals. One or more of the methodologies discussed herein may obviate a need for time consuming data processing, for example, associated with individual queries for information about one or more entities in order to provide relevant information to the user within the context of the user's environment. This can have the technical effect of reducing computing resources used by one or more devices within the system. Examples of such computing resources include, without limitation, processor cycles, network traffic, memory usage, storage space, and power consumption.

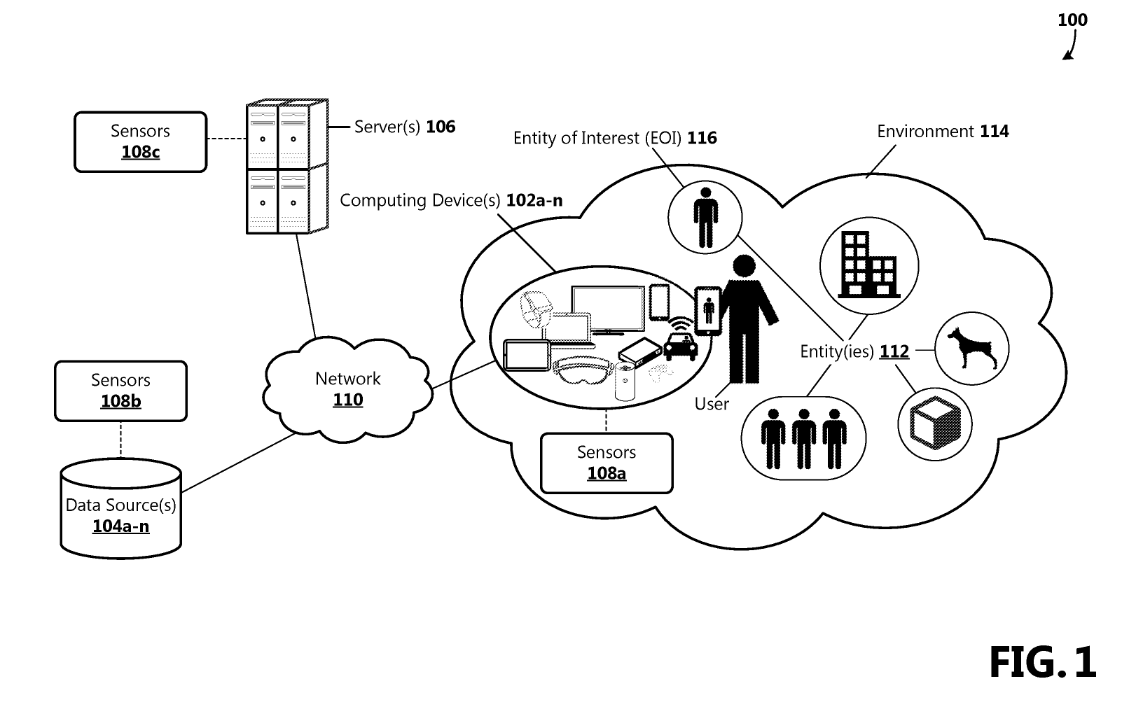

Aspects of the present disclosure are directed to a system, method, and computer readable storage device for providing entity attribute identification. FIG. 1 illustrates an example operating environment 100 in which aspects of the present disclosure can be employed. For example, example operating environment 100 can be used to implement an entity attribute identification system to identify an entity 112 (e.g., a person, an object, a creature, a structure) in a captured image, to determine whether the entity has an association with a user-specified attribute, such as a particular skill, expertise, interest, job function, characteristic, feature, etc., and to provide a response corresponding to the determination. In some examples, augmented reality (AR) technology is used to provide information associated with whether an entity 112 in a user's environment 114 comprises a particular attribute as an information layer on top of a real world view of the entity and the user's environment. It should be understood that the illustrated operating environment 100 and other arrangements described herein are provided as examples. Other arrangements and elements can be used in addition to or instead of those shown in FIG. 1. Various functions described herein as being performed by one or more elements or components can be carried out by hardware, firmware, and/or software. For example, some functions can be carried out by a processor executing instructions stored in memory.

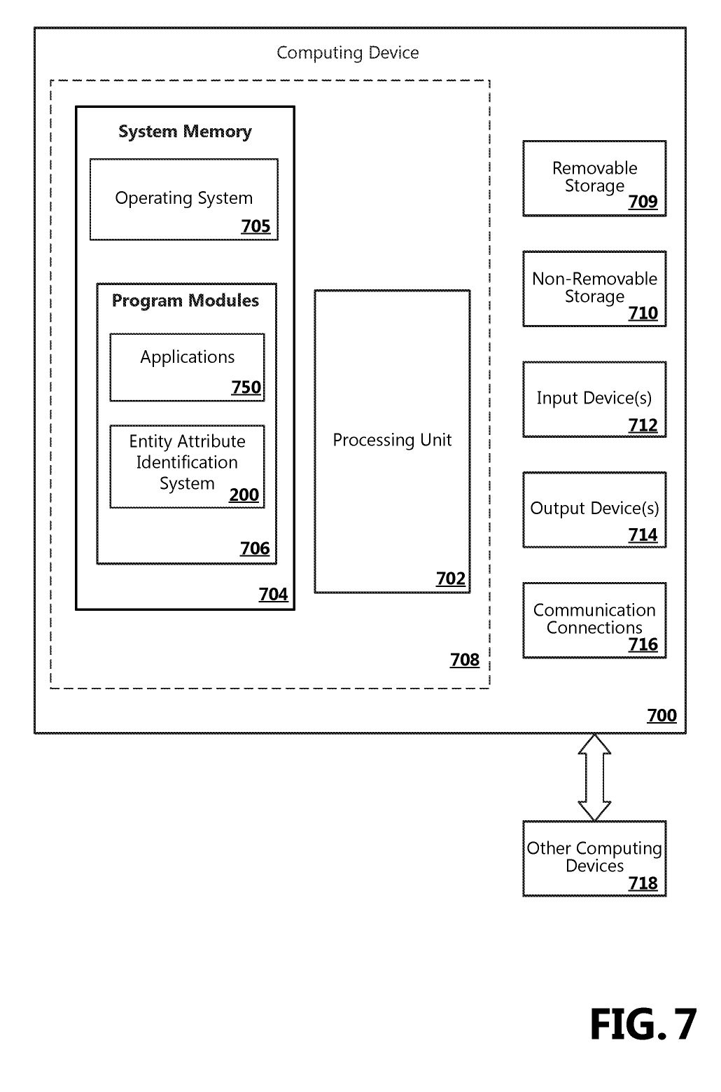

As illustrated, the example operating environment 100 includes one or more computing devices 102a-n (generally 102), one or more data sources 104a-n (generally 104), one or more servers 106a-n (generally 106), sensors 108a-n (generally 108), and a network 110 or a combination of networks. Each of the components illustrated in FIG. 1 can be implemented via any type of computing device, such as the computing devices 700, 800, 905a,b,c described in reference to FIGS. 7, 8A, 8B, and 9. As an example, the one or more computing devices 102 can be one of various types of computing devices, such as tablet computing devices, desktop computers, mobile communication devices, laptop computers, laptop/tablet hybrid computing devices, large screen multi-touch displays, vehicle computing systems, gaming devices, smart televisions, wearable devices, speaker devices, internet of things (IoT) devices, etc.

The components can communicate with each other via a network 110, which can include, without limitation, one or more local area networks (LANs) or wide area networks (WANs). In some examples, the network 110 comprises the Internet and/or a cellular network, amongst any of a variety of possible public or private networks. As should be appreciated, any number of computing devices 102, data sources 104, and servers 106 can be employed within the example operating environment 100 within the scope of the present disclosure. Each can comprise a single device or a plurality of devices cooperating in a distributed environment. For example, the server 106 can be provided via multiple devices arranged in a distributed environment that collectively provide various functionalities described herein. In some examples, other components not shown can be included within the distributed operating environment 100.

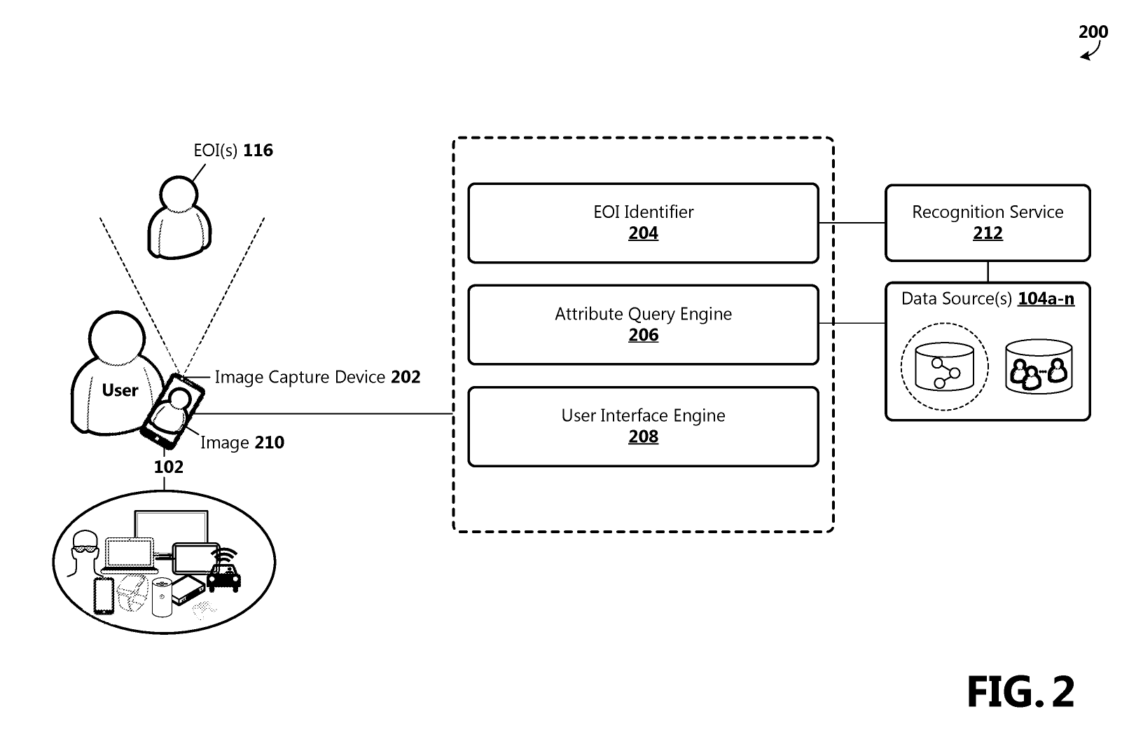

According to an aspect, the one or more data sources 104 can comprise data sources or data systems that are configured to make data available to any of the various components of operating environment 100 or of the example entity attribute identification system 200 described below with reference to FIG. 2. In some examples, the one or more data sources 104 are discrete from the one or more computing devices 102 and the at least one server 106. In other examples, the one or more data sources 104 are incorporated or integrated into at least one of the computing devices 102 or servers 106.

One example data source 104 is a repository of images of entities 112, such as a database of facial images, landmark images, object images, and the like. The data source 104 can include data representing observable characteristics of entities 112. According to an aspect, an image of an entity 112 can be analyzed, and features of the entity can be distilled into values that are stored in a facial image repository. For example, an image of a particular entity or entities of interest (EOI) 116 in a user's environment 114 can be captured, analyzed, and compared against entities and entity features data stored in a facial, landmark, or other object database for identifying the entity(ies).

Another example data source 104 is a knowledge graph illustrative of a repository of entities 112 and relationships between entities. In a knowledge graph, entities are represented as nodes, and attributes and relationships between entities are represented as edges connecting the nodes. Thus, a knowledge graph provides a structured schematic of entities 112 and their relationships to other entities. According to examples, edges between nodes can represent inferred relationships or explicit relationships. A knowledge graph can represent an enterprise's repository of data and knowledge, a social or professional networking service's repository of data and knowledge, or a global repository of data and knowledge (e.g., publicly-accessible, publicly-accessible within the context of the user's enterprise, environment, current activity). For example, a knowledge graph can be used for discovering information associated with an identified EOI 116.

Another example data source 104 is a software development platform repository (e.g., GITHUB®). For example, when a developer contributes code to a project, information associated with the developer's activity is stored and can be made available via a query. Activity information can include information associated with an author, a committer, a file, a date, an organization, a repository, or a topic/keyword. In various examples, data sources 104 comprise and expose APIs (Application Programming Interfaces) that enable a search of the contents of repositories based on search criteria. In some examples, a data source 104 can comprise operational information associated with an enterprise. In other example, a data source 104 can include previously-derived information associated with a previous or a current interaction with an entity 112. Other data sources 104 are possible and are within the scope of the present disclosure.

Aspects of the present disclosure can include a privacy component that enables individuals (entities 112) to opt in or opt out of exposing personal information. The privacy component enables the authorized and secure handling of user information, such as tracking information, as well as personal information that may have been obtained, is maintained, and/or is accessible. In some examples, an entity 112 can be provided with notice of the collection of portions of personal information and an opportunity to opt-in or opt-out of the collection process. Consent can take several forms. Opt-in consent can impose on the entity 112 to take an affirmative action before the data is collected. Alternatively, opt-out consent can impose on the entity 112 to take an affirmative action to prevent the collection of data before that data is collected.

The example operating environment 100 can be used to implement one or more of the components of the example entity attribute identification system 200 described in FIG. 2, including components for providing entity attribute identification. For example, aspects of the example entity attribute identification system 200 receive a user query corresponding to a particular attribute, receive an image including an entity of interest (EOI) 116, identify the EOI 116, retrieve information associated with the identified EOI 116, make a determination as to whether information associated with the identified EOI 116 matches the particular attribute, and notify the user as to whether the identified EOI 116 has an association with the particular attribute. A block diagram is provided that shows aspects of an example computing system architecture suitable for implementing various aspects of the present disclosure. The entity attribute identification system 200 represents only one example of a suitable computing system architecture. Other arrangements and elements can be used in addition to or instead of the elements shown. As should be appreciated, elements described herein are functional entities that can be implemented as discrete or distributed components, or in conjunction with other components, and in any suitable combination or location. In some examples, components of the entity attribute identification system 200 are implemented on a client computing device 102. In other examples components of the entity attribute identification system 200 are implemented on one or a plurality of servers 106. For example, a server 106 is operative or configured to provide data to and receive data from the client computing device 102 through a network 110 or a combination of networks. In some examples, the entity attribute identification system 200 is a hybrid system that includes the client computing device 102 in conjunction with one or more servers 106. The hardware of these computing devices is discussed in greater detail in regard to FIGS. 7, 8A, 8B, and 9.

With reference now to FIG. 2, the example entity attribute identification system 200 includes an entity identifier 204, an attribute query engine 206, and a user interface engine 208. As described above, the components of the example entity attribute identification system 200 can operate on one or more computing devices 102, servers 106, can be distributed across one or more computing devices and servers, or can be implemented in the cloud. In some examples, functions performed by components of the entity attribute identification system 200 are exposed via an API. In some examples, functions performed by components of example system are associated with one or more applications or a digital personal assistant. In some examples, an application is a thick client application, which is stored locally on the computing device 102. In other examples, an application is a thin client application (i.e., web application) that resides on a remote server 106 and is accessible over a network 110 or a combination of networks. A thin client application can be hosted in a browser-controlled environment or coded in a browser-supported language and can rely on a common web browser to render the thin client application executable on the computing device 102. In other examples, an application is a third-party application that is operative or configured to employ functions performed by components of the entity attribute identification system 200 via an API. Digital personal assistant functionality can be provided as or by a stand-alone digital personal assistant application, part of an application, or part of an operating system of the computing device 102.

According to an aspect, the UI engine 208 is illustrative of a software module, system, or device operative to enable a user to interact with functionalities of the example entity attribute identification system 200. In some examples, the UI engine 208 is operative or configured to generate a graphical UI (GUI) for enabling a user to input a user query comprising a mention of an attribute, to activate an image capture device 202 for capturing an image 210 of one or more EOIs 116 in the user's environment 114, and to display information corresponding to whether the one or more EOIs 116 have an association with the particular attribute. In other examples, the UI engine 208 is operative or configured to provide a natural user interface (NUI) that enables a user to interact with the computing device 102 in a “natural” manner for inputting a user query including a mention of an attribute, activating an image capture device 202, and for communicating information to the user corresponding to an entity attribute.

A user query can be received via a variety of input methods, such as those relying on mice, keyboards, and remote controls, as well as NUI methods, such as via speech recognition, touch and stylus recognition, gesture recognition both on screen and adjacent to the screen, air gestures, head and eye tracking, voice and speech, vision, touch, hover, gestures, and machine intelligence. For example, an NUI can include an internal or external microphone, an image capture device 202 (e.g., a camera), and various other types of sensors 108. A spoken utterance can be utilized on its own in support of a particular user experience, while in other examples a spoken utterance can be utilized in combination with other non-voice commands or inputs, such as inputs implementing physical controls on the device or virtual controls implemented on a UI or as inputs using gestures.

In some examples, the attribute mentioned in a user query corresponds to a user need or want, such as a need to find someone who has a particular skill, expertise, interest, or job function. For example: a user in an enterprise may need help with an on-call matter; a patron of a store may need to find someone who can assist with a particular issue; a manager may need to identify one or more workers who can perform a certain duty or task; an individual may be near a restaurant and may want to know whether casual attire is appropriate or has wireless Internet; etc. As an example, if a user wants to know if a specific individual can help with JAVA® programming, the user can speak, “Does this person know JAVA® programming?” As another example, if a user needs to find someone who has experience with Intellectual Property law, the user can enter “Intellectual Property law” into a designated field in a GUI or select “Intellectual Property law” from a list of attribute options. In some examples, a user query is provided following a user selection of an entity attribute identification command or following a preconfigured (spoken) trigger term that operates as a signal to initiate entity attribute identification. In other examples, the user query operates as a trigger term to initiate entity attribute identification.

In some examples, the UI engine 208 includes or is communicatively coupled with a speech recognition engine operative or configured to apply natural language processing and machine learning techniques to understand a user query. In some examples, context information can be collected and used in correlation with a user query to help understand the user intent. For example, context information can include information characterizing a situation related to an entity 112 or to an interaction between users, applications, or the surrounding environment 114. Context information can include data derived from a sensor 108 associated with the user (including location, motion, orientation, position, user-access, user interactions, network-access, user device charging, or other data that is capable of being provided by one or more sensors) and other sources of data that can be sensed or determined as described herein.

According to an aspect, the EOI identifier 204, illustrative of a software module, software package, system, or device, is operative or configured to obtain an image 210 of a user's environment 114. In some examples, the EOI identifier 204 invokes an integrated or communicatively coupled image capture device 202 (e.g., camera) for capturing an image 210 of the user's environment 114 seen through a lens of the image capture device. For example, the image 210 includes at least one EOI 116 about which the user wants information corresponding to an attribute mentioned in an inputted user query. The EOI 116 can be present in the user's environment 114 virtually, or a representation (e.g., photo, scannable quick response code) of the EOI 116 can be present in the user's environment. In some examples, the image capture device 202 is invoked responsive to receiving a user query or responsive to receiving an indication of an expertise identification command. In other examples, a user is enabled to enter a user query subsequent to capturing an image 210 of an EOI 116 via the image capture device 202. The image 210 is a still image (e.g., photo) that can be analyzed immediately or at a later time, a real-time or near real-time video stream that can be analyzed in real-time or near real-time, or a video stream that is captured and stored for analysis at a later time. In one example, the EOI identifier 204 is operative or configured to receive an image 210

According to another aspect, the EOI identifier 204 includes or is communicatively coupled with a recognition service 212, which is operative or configured to use deep learning-based image recognition technology for identifying one or more EOIs 116 in an image 210. For example, the recognition service 212 can include one or more of an image recognition system, a facial recognition system, and a text recognition system. The recognition service 212 is operative or configured to analyze an image 210, distill features of one or more EOIs 116 in the image into data values, and compare the data values of the one or more EOIs 116 in the image to data representing observable characteristics of entities 112 stored in one or more data sources 104, such as a database of facial images, landmark images, or object images, a social media network, etc. The one or more data sources 104 can be associated with a particular user (e.g., associated with a user's contacts list, a user's social network), can be associated with an enterprise, such as a repository of employee images, student images, faculty images, etc., can be a global repository of entity images, etc. In some examples, context information can be collected and used in correlation with image 210 data to identify an EOI 116. Context information can include data derived from a sensor 108 associated with the user (including location, motion, orientation, position, user-access, user interactions, network-access, user device charging, or other data that is capable of being provided by one or more sensors) and other sources of data that can be sensed or determined as described herein.

With reference still to FIG. 2, the attribute query engine 206, illustrative of a software module, software package, system, or device, is operative or configured to receive EOI 116 identification information (e.g., as determined by the EOI identifier 204 or recognition service 212) and query one or more data sources 104 for information associated with one or more identified EOIs 116. For example, the attribute query engine 206 is operative or configured to query a knowledge graph (e.g., an enterprise graph, a social or professional networking graph, a global knowledge graph), a development platform repository, an operational information repository for an enterprise, or other data source 104 or combination of data sources for discovering a relationship between an identified EOI 116 and a user-specified attribute. In some examples, the attribute query engine 206 is operative or configured to query a data source 104 by way of an API. The attribute query engine 206 is further operative or configured to receive query results and determine whether a user-specified attribute is associated with one or more identified EOIs 116. According to an aspect, the attribute query engine 206 makes the determination based on a level of confidence, relevance, or relatedness between an EOI 116 and an attribute (e.g., a strength of an edge between an EOI 116 and an attribute, a number of contributions to a repository or codebase, past interactions with an EOI 116). For example, a confidence level, relevance level, or relatedness level can be calculated based on a source of information (e.g., more trusted sources are ranked higher), a temporal factor (e.g., more recent information can be ranked higher than older information), a quantity of contributions, interaction history with an EOI 116, or other factors.

In some examples, a highest ranking EOI 116 amongst a plurality of EOIs is determined (e.g., an EOI 116 that is most related to the user-specified attribute). For example, in a scenario where a user needs to identify someone who can help with an emergency on-call incident related to software, the user can use AR technology to look around to identify the people who are currently available (i.e., EOIs 116), and then use an API to query a repository (i.e., data source 104) to determine who among them can be most useful/helpful for the current task (e.g., user-specified attribute) at hand. According to an aspect, to determine who is most knowledgeable about a codebase (e.g., related to the user-specified attribute), the attribute query engine 206 is operative or configured to parse the query results to determine which person (i.e., EOI 116) has made the largest number of commits.

Upon making a determination of whether an identified EOI 116 captured in an image 210 is associated with a user-specified attribute (or a determination of a highest ranking EOI 116), information associated with the determination result is provided to the user. According to an aspect, the UI engine 208 is operative or configured to generate a GUI that communicates information associated with the determination result or to provide information associated with the determination result via an audible output (e.g., played through an integrated or communicatively coupled speaker). In some examples, the UI engine 208 is operative or configured to provide augmented reality (AR) functionality. An AR experience can integrate digital information with a user's visual perception of the physical environment 114. For example, AR technology can be used to mediate the user's view of the environment 114 with information associated with an identified EOI 116, such as information corresponding to whether an EOI 116 has an association with a user-specified attribute. In an AR UI, an EOI 116 in the user's environment 114 can have digital information, such as information corresponding to whether an EOI 116 has an association with a user-specified attribute, tethered to it displayed as an overlay. An augmented reality combination of a still image or a live video stream captured by the image capture device 202 can be provided via a variety of display devices, such as a monitor (e.g., on a computing device 102 or on a connected device), a head-mounted display, glasses, a virtual retinal display, and the like.

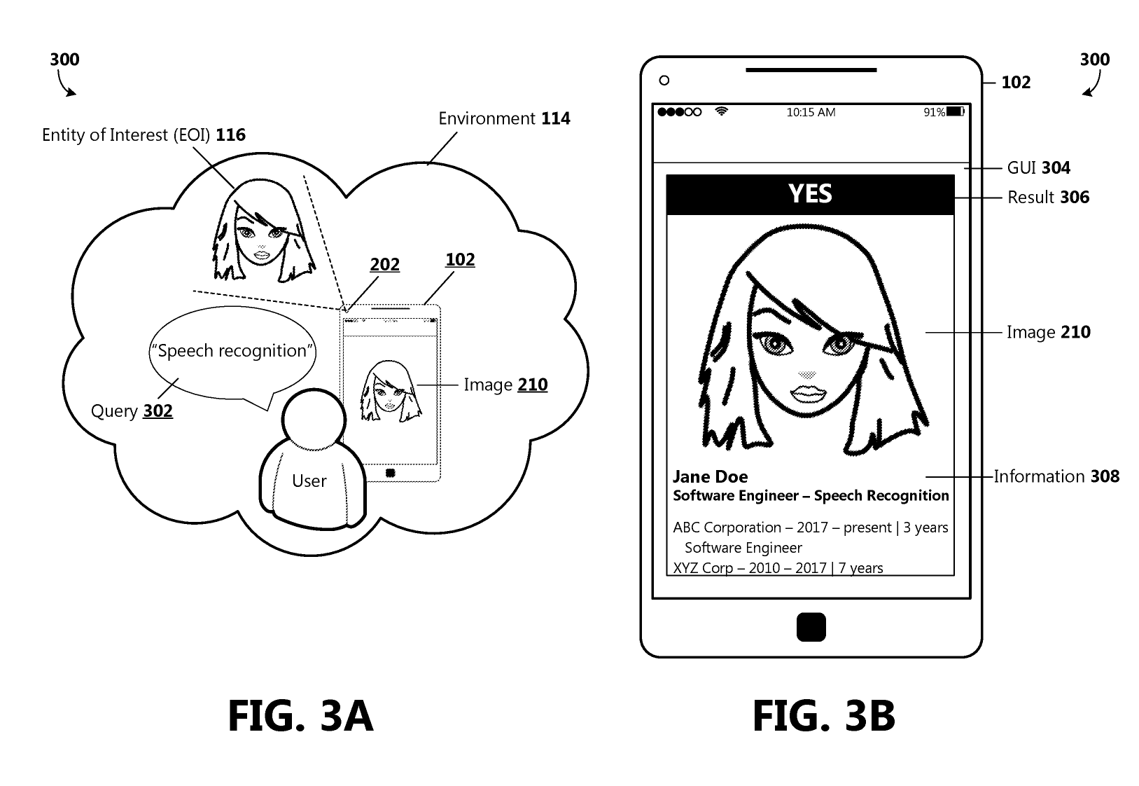

An entity attribute determination result can be provided in a variety of configurations and can include various pieces of information or can include functionalities for triggering an action corresponding to an EOI 116 (e.g., a functionality for obtaining geographical directions to navigate to the EOI 116, a functionality for communicating directly or indirectly with the EOI 116, a functionality for obtaining additional information associated with the EOI 116). For example, a result can include a binary response as to whether an EOI 116 has an association with a user-specified attribute, can include information associated with the EOI 116 or with the user-specified attribute collected from one or more data sources 104, can include geographical directions to navigate to the EOI 116, etc. In some examples, the information or functionalities provided to the user correspond with the type of computing device 102 being utilized by the user. For example, if the user is using a head-mounted display device (e.g., Microsoft's HOLOLENS®, Google's GLASS®), and detects an EOI 116 as a source of help, a functionality can be provided for enabling the user to send a notification to the EOI 116 (e.g., via the EOI's head-mounted display device or other computing device 102 being used by the EOI 116). Various example use case scenarios and UI examples are provided with respect to FIGS. 3A-B, 4A-D, and 5A-5B. As should be appreciated, the illustrated examples are for purposes of example and illustration and are not limiting of a vast number of use cases and UI configurations.

FIGS. 3A and 3B illustrate a first example use case scenario 300. With reference now to FIG. 3A, a user is shown operating a computing device 102 embodied as a mobile phone. The user inputs a user query 302 via speaking an utterance of the attribute “speech recognition,” which is a skill or area of expertise with which the user needs assistance. The user query 302 is provided in association with using the image capture device 202 incorporated in the user's mobile phone to capture an image 210 (e.g., still image or a live video feed) of an EOI 116 in the user's environment 114. In the illustrated example, the EOI 116 is a coworker in the user's organization. The image data are analyzed and matched against a data source 104 comprising images of employees in the user's organization. The EOI 116 is matched with an image and identified as Jane Doe. A data source 104, such as an enterprise knowledge graph or a professional social network source, is queried for information associated with the identified EOI 116 Jane Doe. In particular, the data source 104 is queried for identifying a relationship between the identified EOI 116 and the user-specified attribute “speech recognition.”

According to one example, the attribute query engine 206 can use an API to query a specific repository or codebase (e.g., a speech recognition codebase) of a development platform repository for determining whether the EOI 116 has made commits or other contributions to the repository or codebase (e.g., given the admin(:owner) of the repository, and a repository(:repo)] what are that person's contributions). According to another example, the attribute query engine 206 can query an enterprise knowledge graph for identifying a relationship between the identified EOI 116 and the user-specified attribute “speech recognition.”

With reference now to FIG. 3B, an example GUI 304 is shown that is used to provide an entity attribute determination result 306 to the user. For example, a determination is made that the EOI 116 has an association with speech recognition. Accordingly, a binary result 306 of “yes” is displayed in the GUI 304. In some examples and as illustrated, additional information 308 extracted from one or more data sources 104 is included in the GUI 304. In the illustrated example, the additional information 308 includes the EOI's job title and the EOI's work experience. Based on the entity attribute determination result 306, the user is enabled to determine that the EOI 116 may be useful or helpful for helping the user with the issue for which the user needs assistance.

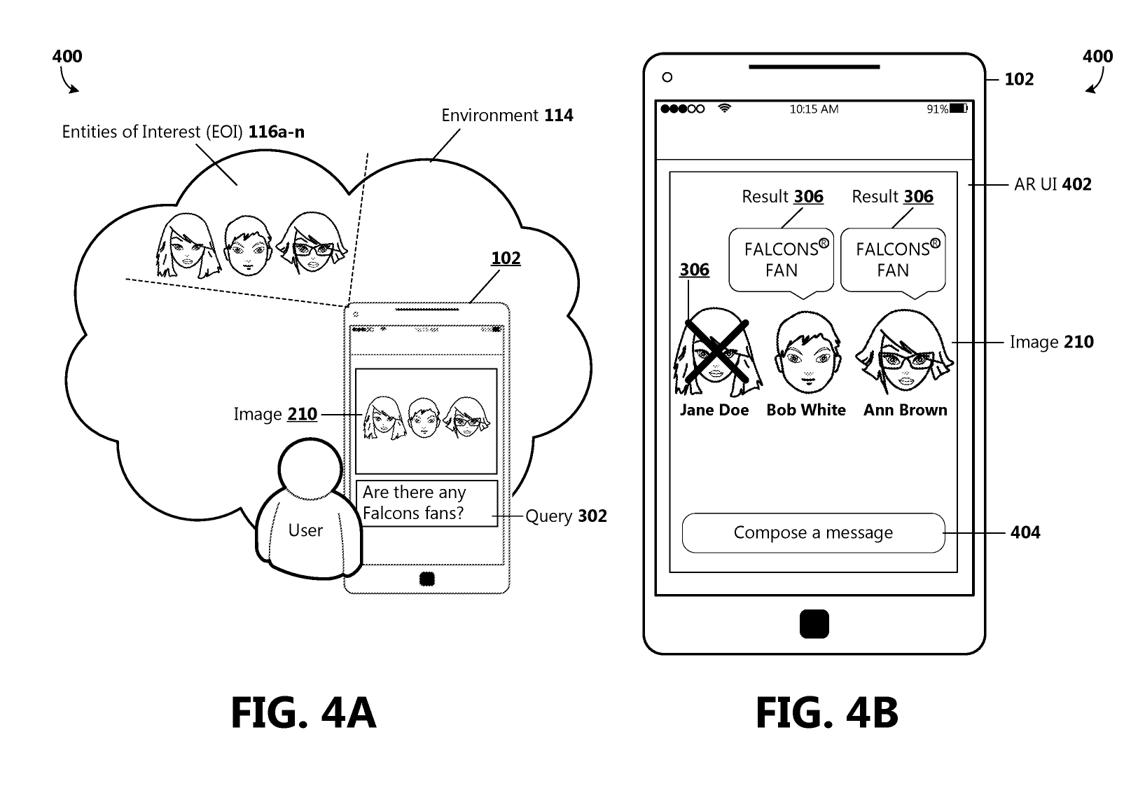

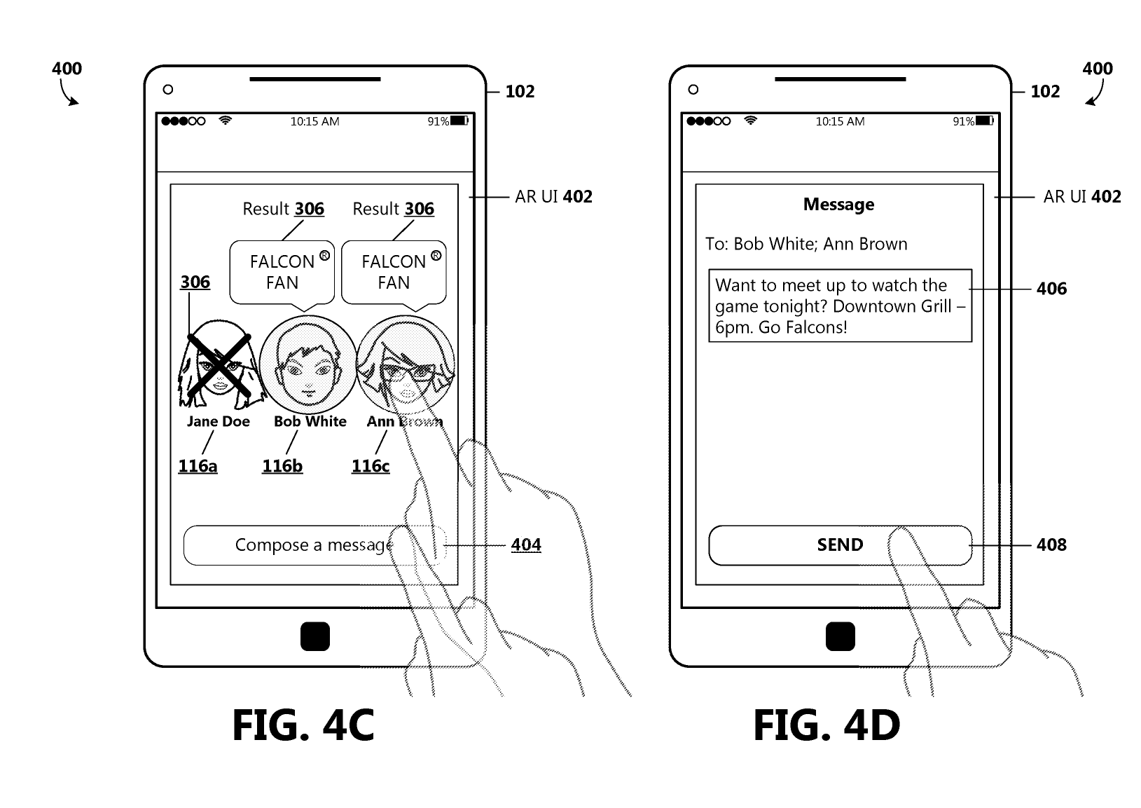

FIGS. 4A-4D illustrate another example use case scenario 400. With reference now to FIG. 4A, a user is shown operating a computing device 102 embodied as a mobile phone. The user inputs a user query 302 via inputting text specifying an attribute “Falcons fan,” which is an interest that the user has and is trying to find other individuals in the user's environment 114 with the same interest. For example, the user may be at a conference and may be trying to find a group of fellow Falcons fans who the user can get together with to watch a game. The user query 302 is provided in association with using the image capture device 202 incorporated in the user's mobile phone to capture an image 210, which in the illustrated example is a live video feed including a plurality of EOIs 116a-n in the user's environment 114. The image data are analyzed and matched against a data source 104 comprising images of attendees of the conference. The EOIs 116a-n are matched with images and are identified. A data source 104, such as a social network source, is queried for information associated with the identified EOIs 116. In particular, the data source 104 is queried for identifying a relationship between the identified EOIs 116a-n and the user-specified attribute “Falcons fan.”

With reference now to FIG. 4B, an example AR UI 402 is shown that is used to provide an entity attribute determination result 306 as an overlay to the captured image 210 (e.g., live video feed). For example, a determination is made that EOI 116b and EOI 116c have an association with the Falcons. Accordingly, as shown in the illustrated example, affirmative entity attribute determination results 306 are displayed in association with EOI 116b and EOI 116c as virtual information tags indicating that the associated EOIs 116b,c are Falcons fans, and a negative entity attribute determination result is displayed in association with EOI 116a as an “X” over the associated EOI 116a, indicating that EOI 116a is not a Falcons fan. As can be appreciated, the illustrated entity attribute determination results 306 are for purposes of example and illustration and are not limiting of a vast number of AR UI 402 configurations. The example AR UI 402 includes additional information 308, such as the identified EOIs' 116a-c names. Based on the entity attribute determination results 306, the user is enabled to determine that the EOIs 116b and 116c are Falcons fans and may be interested in watching a Falcon's game with the user. The example AR UI 402 further includes a functionality control 404 for enabling the user to compose a message to one or more of the EOIs 116a-c.

With reference now to FIG. 4C, the user interacts with the AR UI 402 to select the EOIs 116 that the user wants to message. For example, the user selects EOIs 116b and 116c, and then selects the functionality control 404 to send the selected EOIs 116b,c a message. With reference now to FIG. 4D, the user inputs message content 406, and then selects a functionality control 408 for sending the message to the selected EOIs 116b,c. For example, the message may be sent to the selected EOIs 116b,c via a messaging system integrated with or in communication with the entity attribute identification system 200, via a social networking service, or other messaging channel. As another example, the selected EOIs' 116b,c contact information (e.g., publicly accessible contact information, contact information that is publicly accessible within the context of the user's enterprise, environment, or current activity) may be stored in a data source 104 (e.g., conference attendee database) and made available to components of the system.

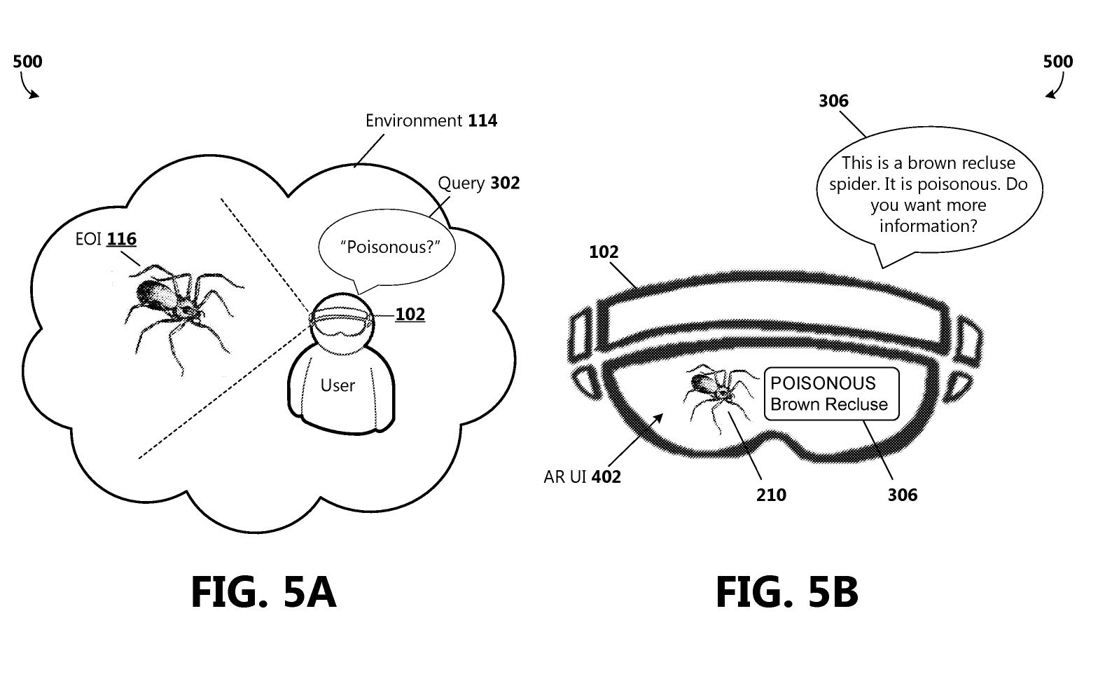

FIGS. 5A and 5B illustrate another example use case scenario 500. With reference now to FIG. 5A, a user is shown wearing a computing device 102 embodied as a head-mounted display. The user inputs a user query 302 via speaking an utterance of the attribute “poisonous,” which is a characteristic about which the user is concerned. For example, the user is using the head-mounted display to view an EOI 116 embodied as a spider, and is wanting to know whether the EOI 116 is poisonous. The user query 302 is provided in association with using the image capture device 202 incorporated in the user's head-mounted display to capture an image 210 (e.g., a live video feed) of the EOI 116 in the user's environment 114. The image data is analyzed and matched against a data source 104 comprising images of spiders. The EOI 116 is matched with an image and identified as a brown recluse spider. A data source 104, such as global knowledge graph, is queried for information associated with brown recluse spiders. In particular, the data source 104 is queried for identifying a relationship between the identified EOI 116 and the user-specified attribute “poisonous.”

With reference now to FIG. 5B, an example AR UI 402 is shown that is used to provide an entity attribute determination result 306 as an overlay to the captured image 210 (e.g., live video feed). For example, a determination is made that the EOI 116 has an association with the user-specified attribute “poisonous.” Accordingly, as shown in the illustrated example, an entity attribute determination result 306 including an indication that the identified EOI 116 is poisonous is displayed as a virtual information tag coupled with the EOI 116 in the captured image 210. Further, another entity attribute determination result 306 embodied as an audible response indicating an identification of the EOI 116 and that the EOI 116 is poisonous is provided as audible output and played through a speaker of the head-mounted display device.

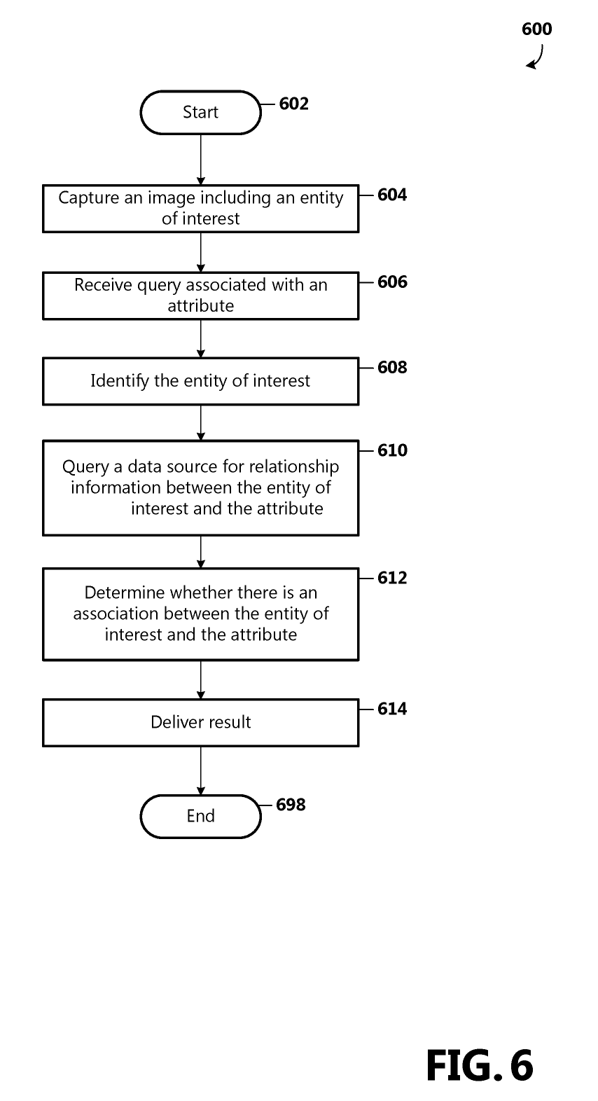

Having described an operating environment 100, an example entity attribute identification system 200 and example use case scenarios 300, 400, and 500 with respect to FIGS. 1, 2, and 3A-5B, FIG. 6 is a flow chart showing general stages involved in an example method 600 for providing entity attribute identification. With reference now to FIG. 6, the method 600 begins at start OPERATION 602, and proceeds to OPERATION 604, where an image 210 of at least one EOI 116 is captured via an image capture device 202 integrated in or coupled with the computing device 102. In some examples, the image 210 is a still shot. In other examples, the image 210 is a live video feed. In other examples, the image 210 is a previously-captured and stored video feed.

The method 600 proceeds to OPERATION 606, where a user query 302 is received. For example, a user utilizes a computing device 102 and speaks an utterance, types text, or utilizes another input method to specify an attribute. The user query 302 can be receive prior to receiving the image 210 (e.g., from the image capture device 202), after receiving the image, or in real-time or near real-time of receiving the image. In some examples, the user query 302 is input following a selection of an entity attribute identification command or following a preconfigured (spoken) trigger term that operates as a signal to initiate entity attribute identification. In other examples, the user query 302 operates as a trigger term to initiate entity attribute identification.

The method 600 continues to OPERATION 608, where the at least one EOI 116 is identified. For example, the image 210 is analyzed, and features of the EOI(s) 116 are compared and matched against entities 112 and entity features data stored in one or more data sources 104 for identifying the EOI(s) 116.

At OPERATION 610, information is retrieved for determining whether the EOI(s) 116 are associated with the user-specified attribute. For example, one or more data sources 104 are queried for identifying a relationship between the EOI(s) 116 and the attribute.

The method 600 proceeds to OPERATION 612, where a determination is made as to whether the EOI(s) 116 are associated with the attribute. For example, the determination can be based on a level of confidence, relatedness, or relevance between an EOI 116 and an attribute (e.g., based on a strength of an edge between an EOI 116 and an attribute, a number of contributions to a repository or codebase, the reputation of the data source 104 providing the EOI-attribute relationship information, a temporal factor, previous interaction(s) with an EOI). In some examples, a highest ranking EOI 116 amongst a plurality of EOIs is determined for identifying the EOI 116 that is most related or most relevant to the user-specified attribute.

The method 600 continues to OPERATION 614, where the entity attribute determination result 306 is provided to the user. For example, the result 306 provides an indication as to whether one or more EOIs 116 in the user's environment 114 are associated with the user-specified attribute. In some examples, the result 306 is displayed in a GUI 302. In other examples, the result 306 is shown in association with one or more EOI(s) 116 in the image 210, for example, as an overlay in an AR UI 402. In other examples, the result 306 is played as an audible output. In other examples, the result 306 is communicated via a tactile alert. As described above, additional information and functionalities can be provided with the attribute determination result 306. The method 600 ends at END OPERATION 698.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 7-9 and the associated descriptions provide a discussion of a variety of operating environments in which examples are practiced. However, the devices and systems illustrated and discussed with respect to FIGS. 7-9 are for purposes of example and illustration and are not limiting of a vast number of computing device configurations that are used for practicing aspects, described herein.

FIG. 7 is a block diagram illustrating physical components (i.e., hardware) of a computing device 700 with which examples of the present disclosure may be practiced. In a basic configuration, the computing device 700 includes at least one processing unit 702 and a system memory 704. According to an aspect, depending on the configuration and type of computing device, the system memory 704 comprises, but is not limited to, volatile storage (e.g., random access memory), non-volatile storage (e.g., read-only memory), flash memory, or any combination of such memories. According to an aspect, the system memory 704 includes an operating system 705 and one or more program modules 706 suitable for running software applications 750. According to an aspect, the system memory 704 includes one or more components of the example entity attribute identification system 200. The operating system 705, for example, is suitable for controlling the operation of the computing device 700. Furthermore, aspects are practiced in conjunction with a graphics library, other operating systems, or any other application program, and is not limited to any particular application or system. This basic configuration is illustrated in FIG. 7 by those components within a dashed line 708. According to an aspect, the computing device 700 has additional features or functionality. For example, according to an aspect, the computing device 700 includes additional data storage devices (removable and/or non-removable) such as, for example, magnetic disks, optical disks, or tape. Such additional storage is illustrated in FIG. 7 by a removable storage device 709 and a non-removable storage device 710.

As stated above, according to an aspect, a number of program modules and data files are stored in the system memory 704. While executing on the processing unit 702, the program modules 706 (e.g., one or more components of the example entity attribute identification system 200) perform processes including, but not limited to, one or more of the stages of the method 600 illustrated in FIG. 6. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 7 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 700 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 700 has one or more input device(s) 712 such as a keyboard, a mouse, a pen, a sound input device, a touch input device, etc. The output device(s) 714 such as a display, speakers, a printer, etc. are also included according to an aspect. The aforementioned devices are examples and others may be used. According to an aspect, the computing device 700 includes one or more communication connections 716 allowing communications with other computing devices 718. Examples of suitable communication connections 716 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. According to an aspect, any such computer storage media is part of the computing device 700. Computer storage media do not include a carrier wave or other propagated data signal.

According to an aspect, communication media are embodied by computer readable instructions, data structures, program modules, or other data in a modulated data signal, such as a carrier wave or other transport mechanism, and includes any information delivery medium. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

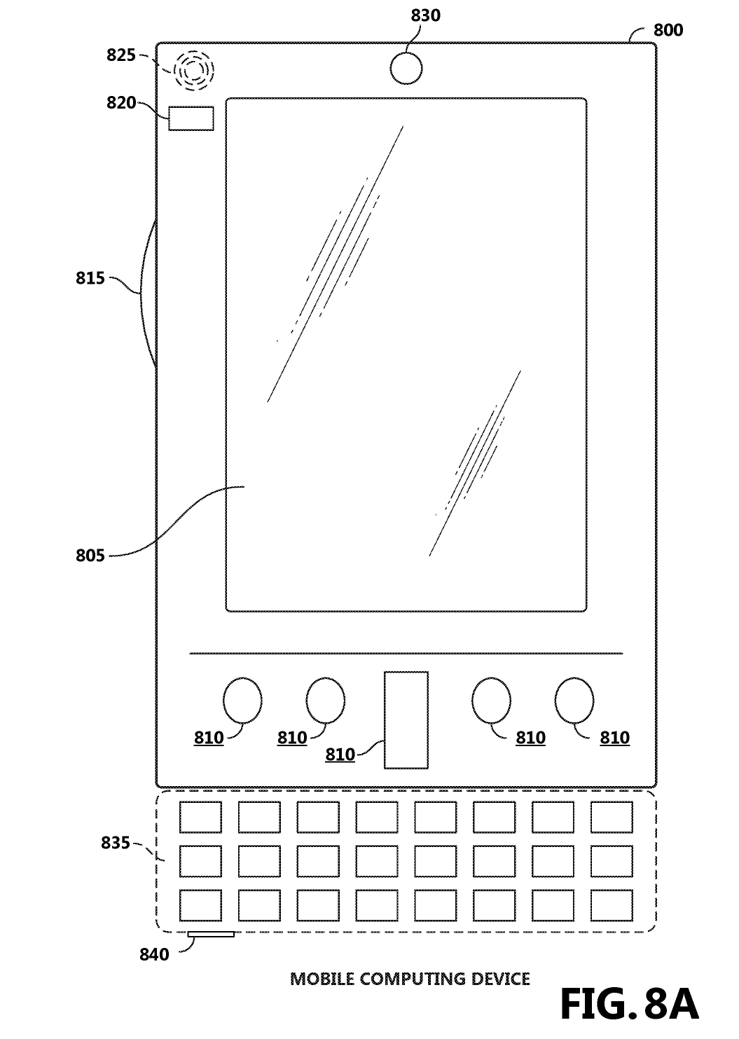

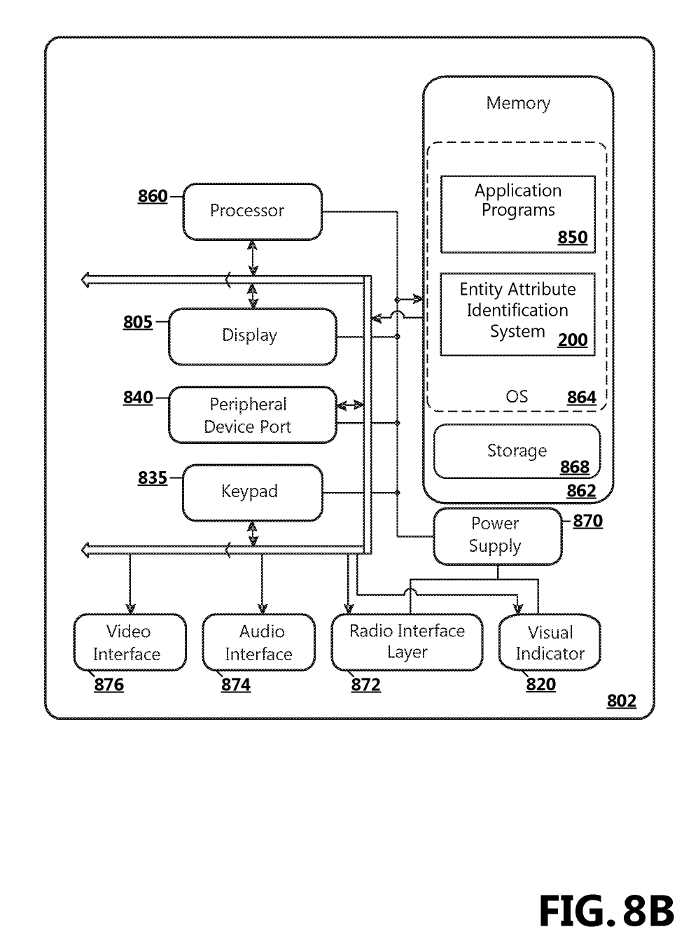

FIGS. 8A and 8B illustrate a mobile computing device 800, for example, a mobile telephone, a smart phone, a tablet personal computer, a laptop computer, and the like, with which aspects may be practiced. With reference to FIG. 8A, an example of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. According to an aspect, the display 805 of the mobile computing device 800 functions as an input device (e.g., a touch screen display). If included, an optional side input element 815 allows further user input. According to an aspect, the side input element 815 is a rotary switch, a button, or any other type of manual input element. In alternative examples, mobile computing device 800 incorporates more or less input elements. For example, the display 805 may not be a touch screen in some examples. In alternative examples, the mobile computing device 800 is a portable phone system, such as a cellular phone. According to an aspect, the mobile computing device 800 includes an optional keypad 835. According to an aspect, the optional keypad 835 is a physical keypad. According to another aspect, the optional keypad 835 is a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some examples, the mobile computing device 800 incorporates a vibration transducer for providing the user with tactile feedback. In yet another example, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 800 incorporates peripheral device port 840, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one example of a mobile computing device. That is, the mobile computing device 800 incorporates a system (i.e., an architecture) 802 to implement some examples. In one example, the system 802 is implemented as a “smart phone” capable of running one or more applications (e.g., browser, e-mail, calendaring, contact managers, messaging clients, games, and media clients/players). In some examples, the system 802 is integrated as a computing device, such as an integrated personal digital assistant (PDA) and wireless phone.

According to an aspect, one or more application programs 850 are loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. According to an aspect, one or more components of the example entity attribute identification system 200 are loaded into memory 862. The system 802 also includes a non-volatile storage area 868 within the memory 862. The non-volatile storage area 868 is used to store persistent information that should not be lost if the system 802 is powered down. The application programs 850 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800.

According to an aspect, the system 802 has a power supply 870, which is implemented as one or more batteries. According to an aspect, the power supply 870 further includes an external power source, such as an AC adapter or a powered docking cradle that supplements or recharges the batteries.

According to an aspect, the system 802 includes a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 850 via the operating system 864, and vice versa.

According to an aspect, the visual indicator 820 is used to provide visual notifications and/or an audio interface 874 is used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. According to an aspect, the system 802 further includes a video interface 876 that enables an operation of an on-board camera 830 to record still images, video stream, and the like.

According to an aspect, a mobile computing device 800 implementing the system 802 has additional features or functionality. For example, the mobile computing device 800 includes additional data storage devices (removable and/or non-removable) such as, magnetic disks, optical disks, or tape. Such additional storage is illustrated in FIG. 8B by the non-volatile storage area 868.

According to an aspect, data/information generated or captured by the mobile computing device 800 and stored via the system 802 is stored locally on the mobile computing device 800, as described above. According to another aspect, the data is stored on any number of storage media that are accessible by the device via the radio 872 or via a wired connection between the mobile computing device 800 and a separate computing device associated with the mobile computing device 800, for example, a server computer in a distributed computing network, such as the Internet. As should be appreciated such data/information is accessible via the mobile computing device 800 via the radio 872 or via a distributed computing network. Similarly, according to an aspect, such data/information is readily transferred between computing devices for storage and use according to well-known data/information transfer and storage means, including electronic mail and collaborative data/information sharing systems.

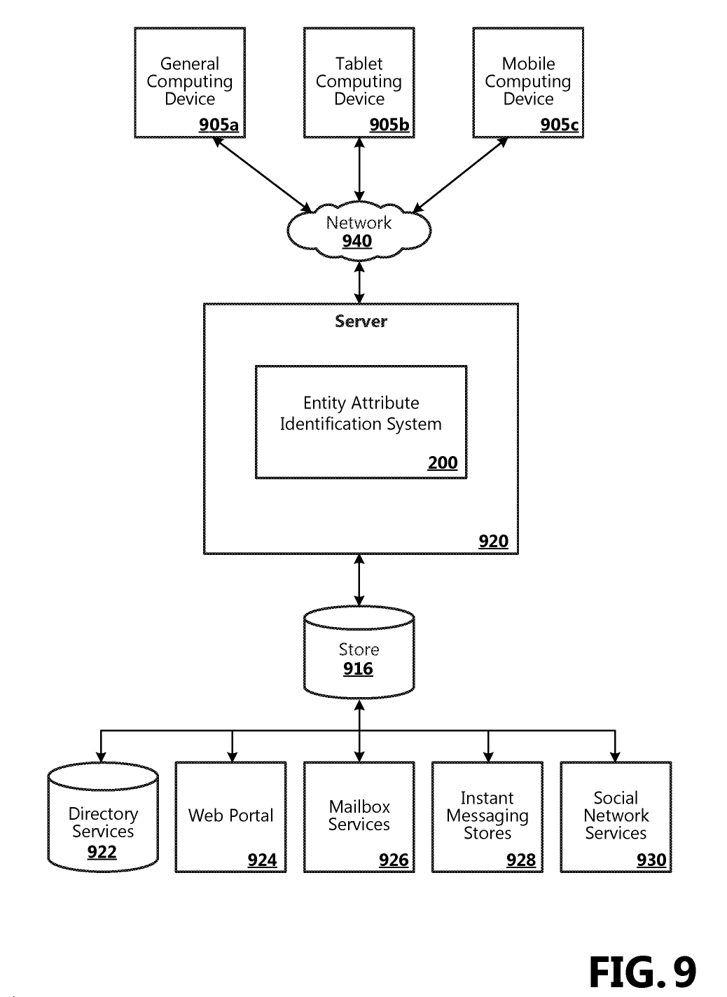

FIG. 9 illustrates one example of the architecture of a system for providing entity attribute identification as described above. Content developed, interacted with, or edited in association with the one or more components of the example entity attribute identification system 200 are enabled to be stored in different communication channels or other storage types. For example, various documents may be stored using a directory service 922, a web portal 924, a mailbox service 926, an instant messaging store 928, or a social networking site 930. One or more components of the example entity attribute identification system 200 are operative or configured to use any of these types of systems or the like for providing entity attribute identification, as described herein. According to an aspect, a server 920 provides the one or more components of the example entity attribute identification system 200 to clients 905a,b,c. As one example, the server 920 is a web server providing one or more components of the example entity attribute identification system 200 over the web. The server 920 provides entity attribute identification over the web to clients 905 through a network 940. By way of example, the computing device is implemented and embodied in a personal computer 905a, a tablet computing device 905b or a mobile computing device 905c (e.g., a smart phone), or other computing device. Any of these examples of the computing device are operable to obtain content from the store 916.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

1. A system for providing entity attribute identification, the system comprising:
at least one processing device; and
at least one computer readable data storage device storing instructions that, when executed by the at least one processing device, cause the system to:
receive an image, wherein the image comprises an entity of interest;
receive a query, wherein the query comprises a statement of an attribute;
identify the entity of interest;
query a data source for relationship information between the entity of interest and the attribute;
determine whether the attribute is associated with the entity of interest; and
present a result indicating whether the attribute is associated with the entity of interest based on the determination.

2. The system of claim 1, wherein the image comprises one of:
a still image;
a real-time or near real-time video feed; or
a previously-recorded video feed.

3. The system of claim 1, wherein in presenting the result, the system is operative or configured to overlay the result over the image using augmented reality technology.

4. The system of claim 1, wherein in presenting the result, the system is operative or configured to provide additional information associated with the entity of interest collected from the data source.

5. The system of claim 1, wherein in presenting the result, the system is operative or configured to provide one or more functionality controls for enabling a user to interact directly or indirectly with the entity of interest.

6. The system of claim 1, wherein in identifying the entity of interest, the system is operative or configured to perform image recognition on the image to identify the entity of interest using at least one data source comprising a plurality of entities and associated images.

7. The system of claim 1, wherein the system is further operative to perform speech recognition on the received query to identify the attribute.

8. The system of claim 1, wherein in receiving the query comprising the statement of the attribute, the system is operative or configured to receive a query comprising a statement of an attribute selected from a group comprising:
a skill;
an expertise;
a job function;
an interest;
a characteristic; and
a feature.

9. The system of claim 1, wherein the data source is one of:
an enterprise knowledge graph;
a social networking service knowledge graph;
a professional networking service knowledge graph;
a global repository of data and knowledge; or
a software development platform repository.

10. The system of claim 9, wherein in querying the data source, the system is operative or configured to query the data source via an application programming interface.

11. The system of claim 1, wherein in determining whether the attribute is associated with the entity of interest, the system is operative or configured to calculate a score indicating a confidence level of the relationship between the entity of interest and the attribute, the score based on at least one of:
a strength of an edge between the entity of interest and the attribute;
a number of contributions to a repository or codebase associated with the attribute by the entity of interest;
the data source;
interaction history between a user and the entity of interest; and
a temporal factor.

12. The system of claim 1, wherein the entity of interest is an entity selected from the group comprising a person, an object, a creature, and a structure.

13. The system of claim 1, wherein the image comprises a plurality of entities of interest; and wherein the system is further operative or configured to:
query a data source for relationship information between the each entity of the plurality of entities of interest and the attribute;
determine whether the attribute is associated with each entity of the plurality of entities of interest;
determine a most relevant entity of interest from the plurality of entities of interest; and
present a result indicating that the determined most relevant entity of interest is associated with the attribute based on the determination.

14. A computer-implemented method for providing entity attribute identification, the method comprising:
receiving an image, wherein the image comprises one or more entities of interest;
receiving a query, wherein the query comprises a statement of an attribute;
identifying the one or more entities of interest via image recognition;
querying one or more data sources for relationship information between each of the one or more entities of interest and the attribute;
determining whether the attribute is associated with each of the one or more entities of interest; and
presenting results indicating whether the attribute is associated with each of the one or more entities of interest based on the determination.

15. The method of claim 14, wherein receiving the image comprises receiving one of:
a still image;
a real-time or near real-time video feed; or
a previously-recorded video feed.

16. The method of claim 14, wherein in presenting the result, the system is operative or configured to overlay the result over the image using augmented reality technology.

17. The method of claim 14, wherein querying one or more data sources comprises querying one or more of:
an enterprise knowledge graph;
a social networking service knowledge graph;
a professional networking service knowledge graph;
a global repository of data and knowledge; or
a software development platform repository.

18. The method of claim 14, wherein determining whether the attribute is associated with each of the one or more entities of interest comprises calculating a score indicating a confidence level of the relationship between each entity of interest and the attribute, the score based on at least one of:
a strength of an edge between each entity of interest and the attribute;
a number of contributions to a repository or codebase associated with the attribute by each entity of interest;
the data source;
interaction history between a user and each entity of interest; and
a temporal factor.

19. The method of claim 14, further comprising:
calculating a score for each entity of interest indicating a relatedness level between each entity of interest and the attribute;
determining a highest ranking entity of interest amongst the plurality of entities of interest as most related to the attribute; and
presenting a result indicating that the highest ranking entity of interest is associated with the attribute based on the determination.

20. A computer readable storage device including computer readable instructions, which when executed by a processing unit is operative to:
capture a still or video image, wherein the image comprises one or more entities of interest;
receive a query, wherein the query comprises a statement of an attribute;
identify the one or more entities of interest via image recognition;
query one or more data sources for relationship information between each of the one or more entities of interest and the attribute;
make a determination as to whether the attribute is associated with each of the one or more entities of interest, wherein in making the determination, the processing unit is operative to:
calculate a score indicating a confidence level of the relationship between each entity of interest and the attribute, the score based on at least one of:
a strength of an edge between each entity of interest and the attribute;
a number of contributions to a repository or codebase associated with the attribute by each entity of interest;
the data source;
interaction history between a user and each entity of interest; and
a temporal factor; and
generate an augmented reality display overlaying results indicating whether the attribute is associated with each of the one or more entities of interest based on the determination.
